(19) United States
(12) Patent Application Publication
(10) Pub. No.: US 2007/0011035 A1
(43) Pub. Date: Jan. 11, 2007

(54) System and method for optimizing transportations assignments and mainetenance activities

(76) Inventor: Ofir Yaffe, Raanana (IL)

Correspondence Address: LAW OFFICES OF BRIAN S STEINBERGER, 101 BREVARD AVENUE, COCOA, FL, 32922, US

(21) Appl. No.: 10/569,667

(22) PCT Filed: Jan. 11, 2004
(86) PCT No.: PCT/IL04/00025

§ 371 Date: Feb. 24, 2006

(30) Foreign Application Priority Data
Aug. 25, 2003 (IL) 157568

(51) Int. Cl. G06F 17/50

(52) U.S. Cl. 705/7

(57) ABSTRACT

The present invention discloses an optimization method for minimizing costs of transportation task assignment and maintenance scheduling under constraints of defined target tasks which are to be carried out by different types of transportation devices, each having different capabilities and maintenance requirements. The optimization method is based on an objective formula defined according penalty or costs of calculated deviations from target tasks. The objective formula is activated under constrains rules, which relate to transportation device competence, maintenance requirements, scheduling constrains and target task requirements. The optimization process yields an output list of assignment and scheduling timetables of targeted tasks and maintenance plan for each airplane.

### BACKGROUND OF THE INVENTION

The present invention relates optimization methods for transportation assignments and maintenance planning. More specifically, the invention relates to a system and method for planning airplane flights and maintenance scheduling.

Prior art methodologies of transportation assignment problems utilize decision support and expert systems tools which enable generating flight timetables. Such prior art systems are not capable of cost optimization for flights assignment and scheduling within given constrains.

One solution to overcome this problem is disclosed “Aircraft Scheduling and Operation—a Constraint Programming Approach” by Erik Kilborn (Department of Computing Science Chalmers University of Technology and Goteborg University SE-412 96 Göteborg, Sweden Goteborg, December 2000) which uses constraint programming techniques for aircraft scheduling under resources constrains. This work provides a solution for assignment and scheduling but does not include maintenance scheduling constrains. Furthermore, this technique is unable to provide cost optimization solutions under constrains for defined tasks.

Existing assignment and scheduling problems of modern transportations environments emanate from the need to take into consideration not only the basic constrains such as transportation device capabilities, but also maintenance scheduling and complex assignment requirements.

When referring to complex and large-scale transportation environments such as aircrafts, trains etc., it is even more important to consider the economic consequence of unexploited resources and the cost of unfulfilled tasks.

The main object of the invention is to avoid the limitations of prior art and provide an optimization method and system for transportation assignment and scheduling problems involving multiple constrains.

### SUMMARY OF THE INVENTION

The present invention disclose an optimization method for minimizing costs of transportation task assignment and maintenance scheduling under constraints of defined target tasks which are to be carried out by different types of transportation devices, each having different capabilities and maintenance requirements. The method comprise the steps of: defining penalty or costs for any deviation from target tasks or maintenance requirements, defining (cost optimization) an objective formula which is based on defined penalty or costs and calculated deviations from target tasks, defining formulas which express rules, wherein said rules relate to transportation device competence, maintenance requirements, scheduling constrains, and target task requirements, running optimization process based on defined optimization formulas and defined rules and recording output data of assignment and scheduling time table of target tasks and maintenance plan for each airplane.

### BRIEF DESCRIPTION OF THE DRAWINGS

These and further features and advantages of the invention will become more clearly understood in light of the ensuing description of a few preferred embodiments thereof, given by way of example only, with reference to the accompanying drawings, wherein

FIG. 1 is a general scheme of present invention system;

FIGS. 2 and 2a are example of input of parameters, formulas and variables according to the present invention;

FIG. 3 is an example of constrains rules according to the present invention;

FIG. 4 is an example of a truth table and relevant constrains rules according to the present invention;

FIG. 5 is a flow-chart representing the optimization process according to the present invention.

### DETAILED DESCRIPTION OF THE PREFERRED EMBODIMENTS

The present invention provides a new system and methods for solving cost optimization problems of scheduling transportation assignment within complex environments involving multiple constrains of task assignments and maintenance scheduling requirements.

The preferred embodiment of the invention relates to flight assignments and maintenance scheduling of military aircrafts, although the optimization model proposed by the present invention may be utilized by any other transportation environment.

When assigning and scheduling military aircrafts flights, multiple types of constraints and requirements are to be considered. The first type refers to a maintenance plan, which defines for example, for each type of aircraft, the required essential maintenance operations to be preformed at predetermined intervals. The second type refers to a training plan, which defines for example, the required number of essential flight hours for each type of aircraft to be preformed over predefined periods. The third type of constraint refers to the tasks or missions types which have to be preformed by a specific type of aircraft over a specific period of time.

According to the present invention the optimization model is designed not only to find an assignment and scheduling scheme, which satisfies all requirements under given constraints, but also minimize the cost of such scheme.

The consequence of not fulfilling any type of requirement such as completing missions, tasks, training plans or maintenance operations can be evaluated in terms of cost.

The present invention suggests an optimizing model which includes designated rules enabling the definition of each type of constrains in mathematical form.

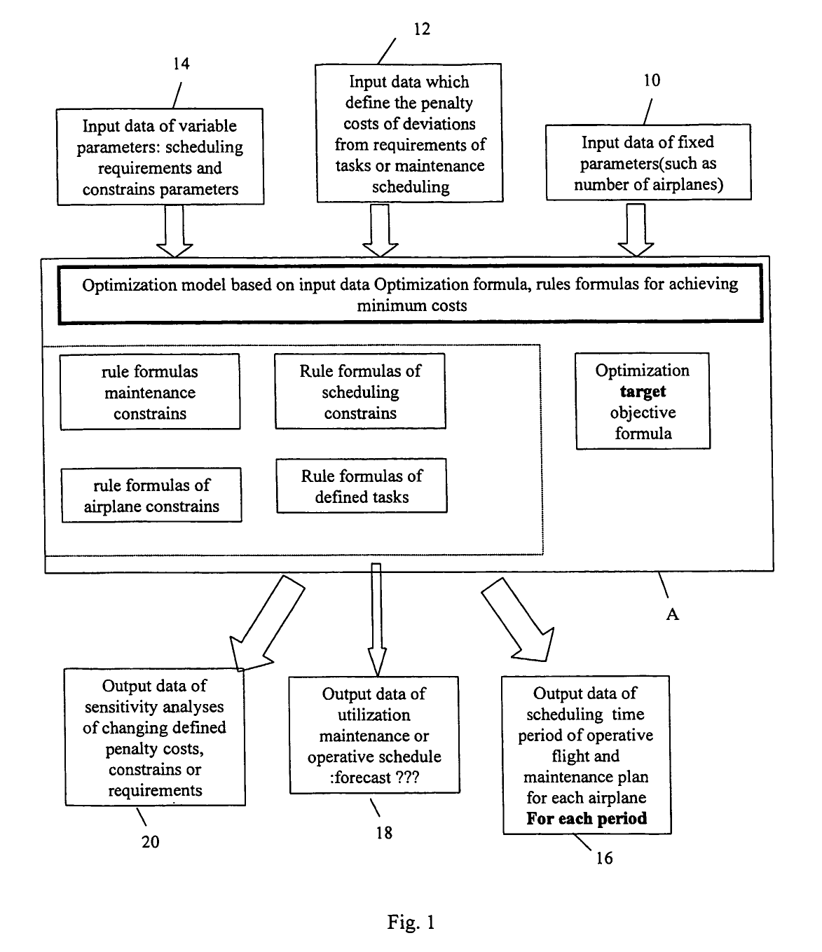

FIG. 1 is a block diagram illustrating the general information flow of the optimization problem as defined by the present invention.

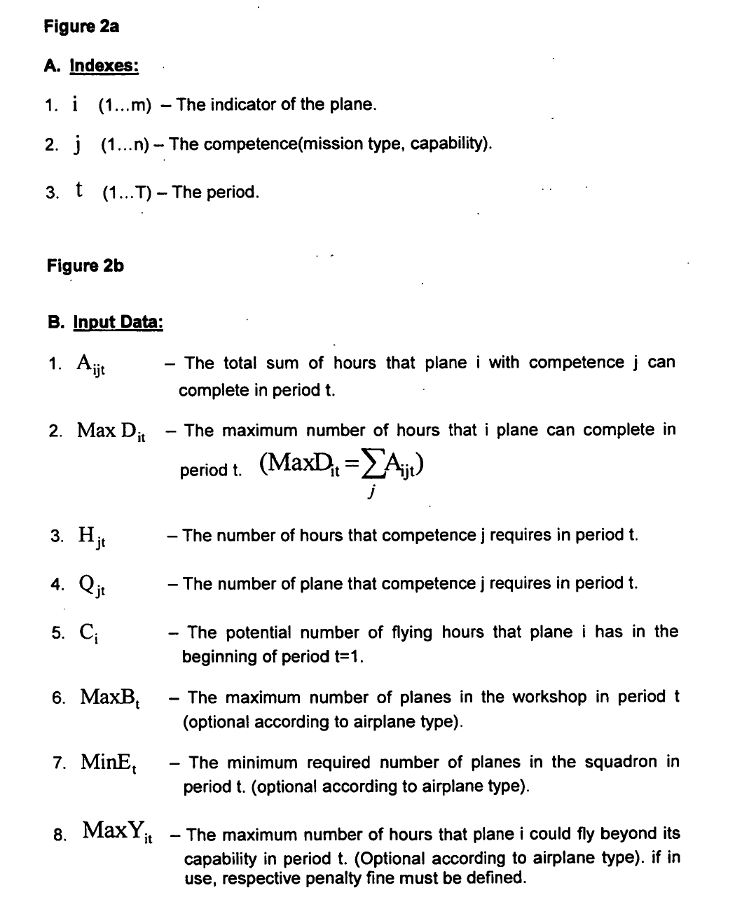

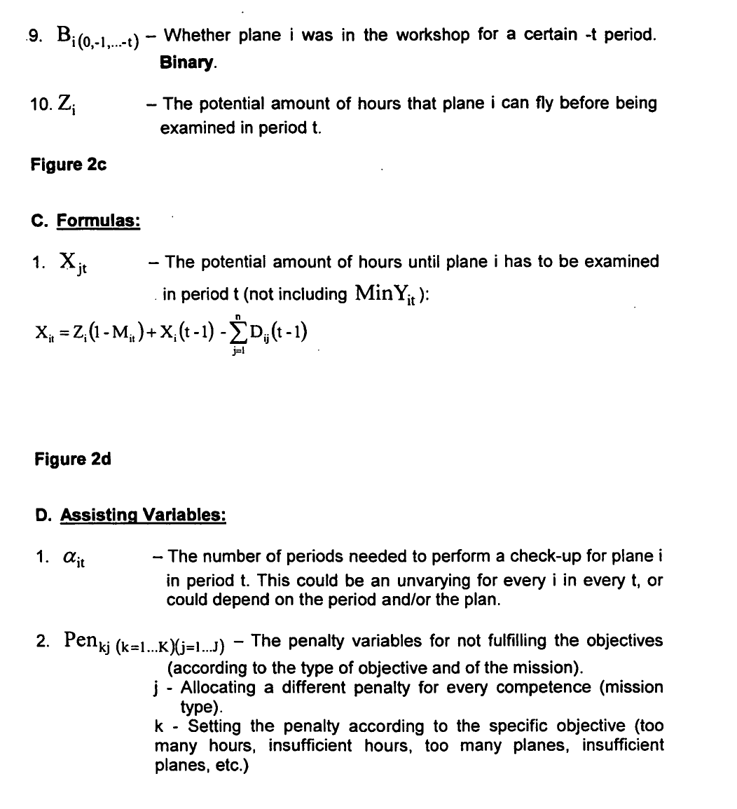

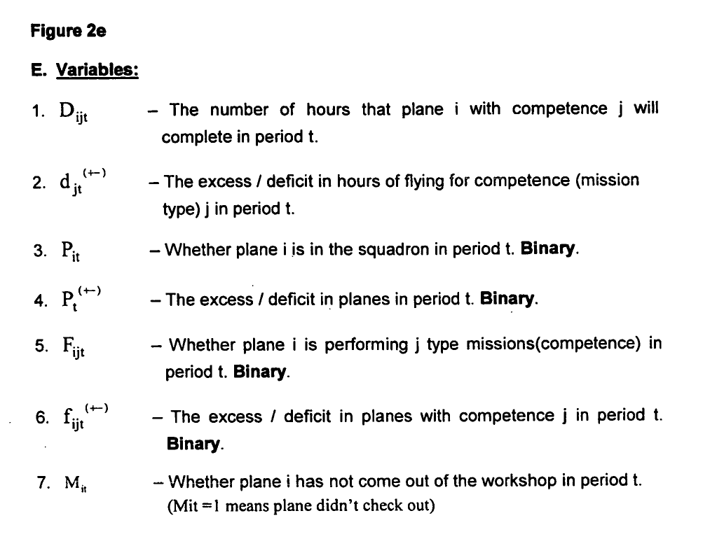

Referring to FIG. 1 of the drawings, it can be seen that optimizing model A receives three types of inputs. The first type are the input (10) of fixed parameters of the airplane system, such as number of airplanes (i) their competence (j) of performing different mission types, the maintenance workshops capacity, and constrains parameters which are further described in FIG. 2. The second type 12 include the input of all variable parameters referring to the planning of future periods, mission schedules and the determining of specific limitations. The third type of parameters 14 include penalty or costs which define the fine for each deviation from plan scheduling or from the maintenance plan.

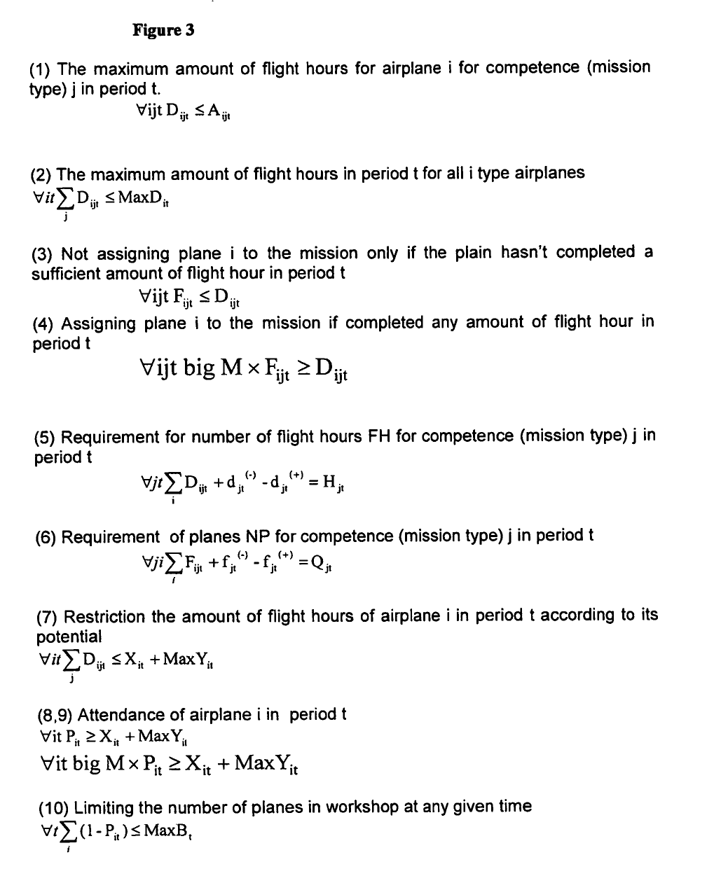

The optimizing model includes an objective formula A and optimization rules 18 which are further detailed in FIG. 3.

FIG. 2 is an example of typical input. These inputs are given only as an example, each type of airplane or transportation system may include different types of constrains. Typically, there are three type of constrains: airplane capability limitations, such as the maximum number of flight hour for plane i over period t; maintenance limitation such as service capability of a workshop; scheduling requirements constrains such number of missions to be preformed over period t.

FIG. 3 is a suggestion for optimization rules constrain. These rules are given only as an example, each type of airplane or transportation system may have different type of rules in according to the different characteristics of the system. The rules are classified according to airplane constrains, maintenance limitations and scheduling requirements.

The rules constrains are constructed from the input parameters as described above and defined variables parameters. The variables parameters define working process measurements indicating of the transportation system status. Some of these parameters are quantitative values such as how much hours plane i of competence j have done at time period t (Dᵢⱼₜ). Other parameters are binary such as: plane I is available at period time t: yes or no (value of 1 or 0).

The rules constrains define mathematical equations which represent the respective constrains. Some of these equations which are known in the art, are of simple structure and there meaning need not to be explained. For example Maximum limitation of flight hours of plane i with competence J at period t is expressed by the formula Dᵢⱼₜ<Aᵢⱼₜ.

According to the present invention, new types of mathematical equations are suggested. The rules based on these equations enable to define complex requirements and constrains.

These equations are based on algorithm, which represent a truth table of possible scenarios. The equations are defined so that, their results express the occurrence of specific situations.

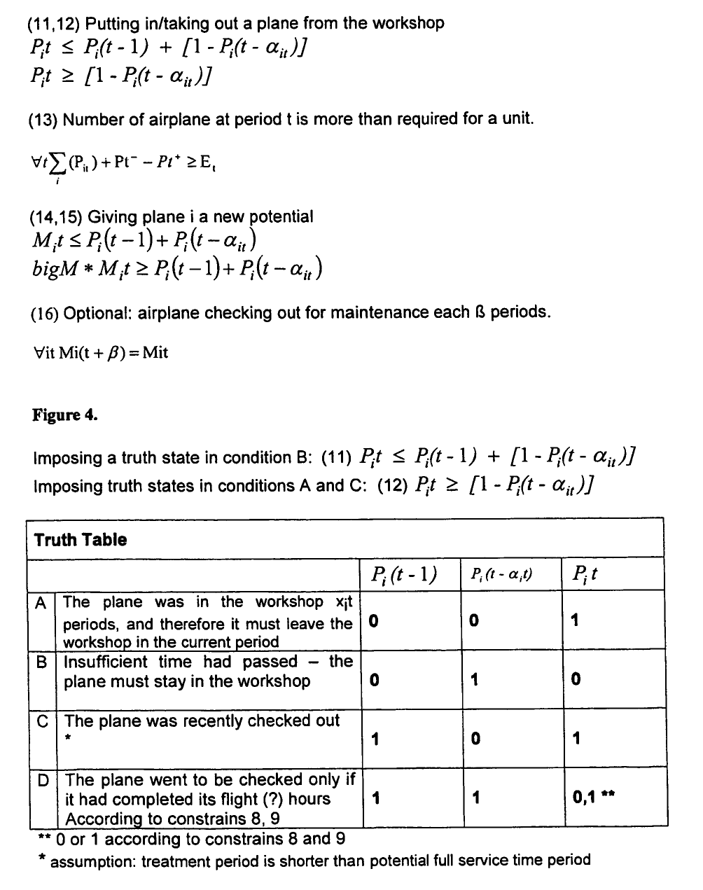

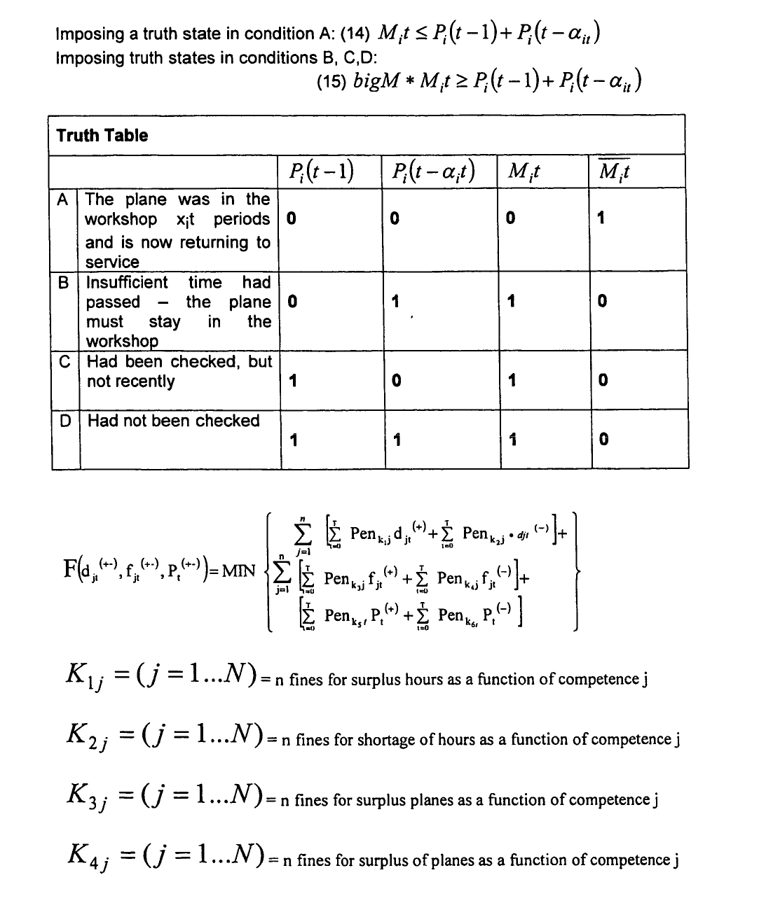

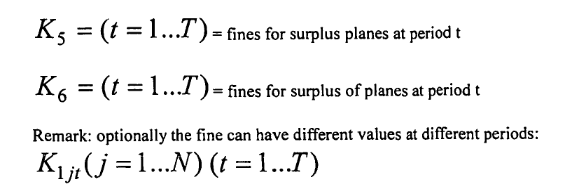

For example let us assume that one of the demands which is to be considered in the optimization models is the requirement to release a plane from the workshop. For enforcing the optimization model output results to include such requirement, is defined a truth table which include possible scenarios of plane maintenance status. For example: first status indicates the plane has already stayed at the workshop for number of periods, a second status indicates that more time periods are required for the plane to stay in the work shop. (see FIG. 4 of this example). Each scenarios is expressed by binary variable parameters of the truth table. A combination of mathematical formula limit these binary parameters to receive specifics results which represent the occurrence of specific scenario.

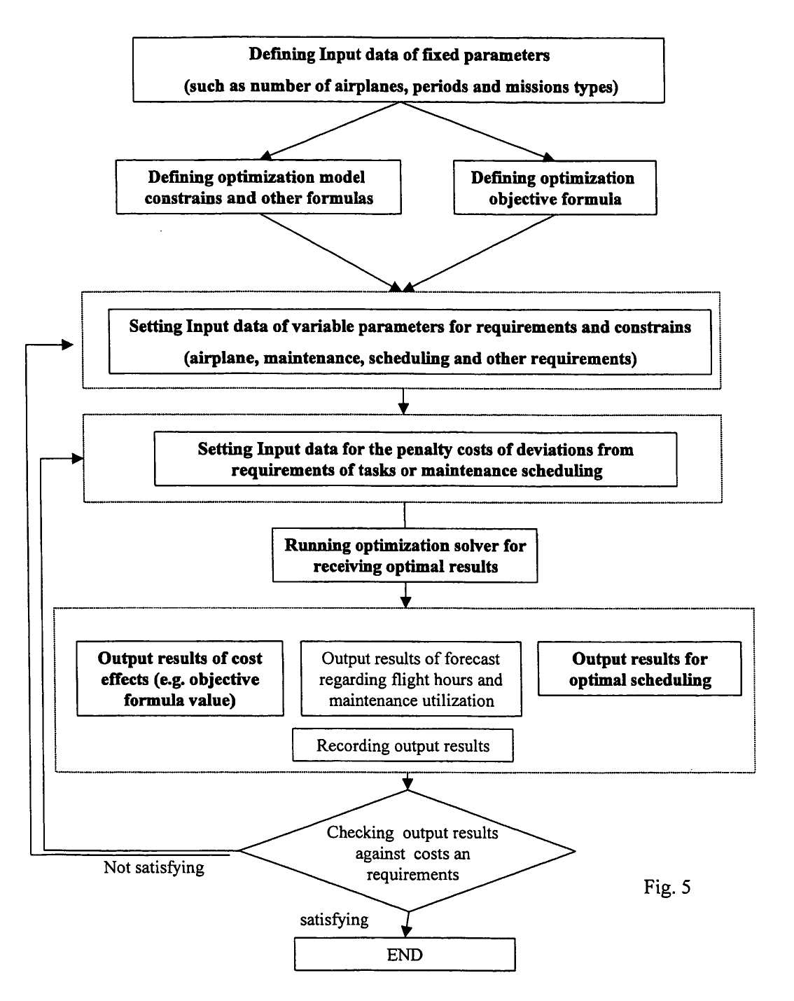

FIG. 5 illustrates the information flow of the optimization process according to the present invention. The optimization application is fed with input information of fixed parameters, variable parameter which include all scheduling and constrains requirements and penalty costs parameters.

Once all data is entered, a the optimization application runs according the objective formula and rules. The optimization results scheduling scenarios of flight and maintenance scheduling, forecasts of flight hour utilization and maintenance status and cost effect analysis report. The output results are checked against costs targets and required mission scheduling. If the results does not satisfy the some of one of the constrains or targets, the users may change the variable parameters or the costs according to theirs consideration and runs the optimization process again.

While the above description contains many specificities, these should not be construed as limitations on the scope of the invention, but rather as exemplifications of the preferred embodiments. Those skilled in the art will envision other possible variations that are within its scope. Accordingly, the scope of the invention should be determined not by the embodiments illustrated, but by the appended claims and their legal equivalents.

What is claimed is:

1. A method of optimization for minimizing costs of transportation task assignment and maintenance scheduling under constraints of defined target tasks which are to be carried out by different types of transportation devices, each having different competence and maintenance requirements, said method comprising the steps of:
Defining penalty or costs for any deviation from target tasks or maintenance requirements;
Defining (cost optimization) an objective formula which is based on defined penalty or costs and calculated deviations from target tasks;
Defining formulas which express rules, wherein said rules relate to transportation device capabilities, maintenance requirements, scheduling constrains, and target task requirements.
Running optimization process based on defined optimization formula and defined rules;
Recording output data of assignment and scheduling time table of target tasks and maintenance plan for each airplane.

2. The method of claim 1 wherein the rules of transportation device capabilities include a constraint of required number of hours at any period T of transportation of competence J.

3. The method of claim 1 wherein the rules of transportation device restriction of assigning transportation device only if preformed number of hour for period t of transportation of competence j.

4. The method of claim 1 wherein the rules limits the attendance of transportation i at period t.

5. The method of claim 1 wherein the rules restrict the flight hours for period t of airplane according to potential.

6. The method of claim 1 wherein the rules restrict the number of planes in workshop at period t.

7. The method of claim 1 wherein the rules determine the requirement for number of usage hour FH for competence j at period t.

8. The method of claim 1 wherein the rules determine requirement of planes NP for competence j at period t.

9. The method of claim 1 wherein the rules further express specific requirement which is defined according to set of scenarios, each scenario represented by set of binary variable parameters values, wherein the mathematical rules equations constrain the values of said binary variable parameters.

10. The method of claim 1 wherein the transportation devices are airplanes.

11. The method of claim 1 wherein the transportation devices type represent the transportation device capability to perform certain type of mission.

12. The method of claim 1 further comprising the step of analyzing optimization results for resulting forecasts of hour usage utilization and maintenance status.

13. The method of claim 1 further comprising the step of analyzing optimization results for resulting sensitivity analyses relating cost effects or scheduling.

14. The method of claim 1 further comprising the step of analyzing optimization results for resulting reports of hour usage utilization and maintenance status.

15. The method of claim 1 further comprising the steps of:
checking output results against target costs and required missions scheduling;
changing penalty costs or changing scheduling constrains and running optimization process if output results don't satisfy target costs or required mission scheduling.

16. A system for optimizing costs of transportation task assignment and maintenance scheduling under constraints of defined target tasks which are to be carried out by different types of transportation devices, each having different capabilities and maintenance requirements, said system comprised of:
An optimization application based on defined optimization formula and defined rules wherein the optimization objective formula is based on defined penalty costs for any deviation from target tasks or maintenance requirements and wherein the defined rules formulas express rules which relate to transportation device competence, maintenance requirements, scheduling constrains, and target task requirements.
Output data results analysis module of assignment and scheduling time table of target tasks and maintenance plan for each airplane.

17. The system of claim 17 wherein the rules of transportation device capabilities include a constraint of Max/min number of usage hours at any period T of transportation competence J.

18. The system of claim 17 wherein the rules of transportation device restriction of assigning transportation device only if preformed number of hour for period t of transportation competence j.

19. The system of claim 17 wherein the rules limits the attendance of transportation l at period t.

20. The system of claim 17 wherein the rules restrict the flight hours at period t of airplane i according to potential.

21. The system of claim 17 wherein the rules restrict the number of planes in workshop at period t.

22. The system of claim 17 wherein the rules determine the requirement for number of usage hour FH for competence j at period t.

23. The system of claim 17 wherein the rules determine requirement of planes NP for competence j at period t.

24. The system of claim 17 wherein the rules restrict

25. The system of claim 17 wherein the rules further express specific requirement which is defined according to set of scenarios, each scenario represented by set of binary variable parameters values, wherein the mathematical rules equations constrain the values of said binary variable parameters.

26. The system of claim 17 wherein the transportation devices are airplanes.

27. The system of claim 17 wherein the transportation devices type represent the transportation device capability to perform certain type of mission.

28. The system of claim 17 further comprising a module for analyzing optimization results for resulting forecasts of hour usage utilization and maintenance status.

29. The system of claim 17 further comprising the module of analyzing optimization results for resulting sensitivity analyses relating cost effects or scheduling.

30. The system of claim 17 further comprising the module of analyzing optimization results for resulting reports of hour usage utilization and maintenance status.

31. The system of claim 17 further comprising the modules of:
checking output results against target costs and required missions scheduling;
changing penalty costs or changing scheduling constrains and running optimization process if output results don't satisfy target costs or required mission scheduling.
